(19) United States
(12) Patent Application Publication
(10) Pub. No.: US 2004/0065661 A1
(43) Pub. Date: Apr. 8, 2004

(54) Heat-emitting hand-held object

(76) Inventor: Georg Wiegner, Hong Kong (CN)

Correspondence Address: DORSEY & WHITNEY LLP, INTELLECTUAL PROPERTY DEPARTMENT, 4 EMBARCADERO CENTER, SUITE 3400, SAN FRANCISCO, CA, 94111, US

(21) Appl. No.: 10/451,452

(22) PCT Filed: Dec. 19, 2001
(86) PCT No.: PCT/EP01/15064

(30) Foreign Application Priority Data
Dec. 21, 2000 (DE) 10064429.5
Mar. 22, 2001 (EP) 01107194.1
Mar. 29, 2001 (DE) 20105612.7

(51) Int. Cl. H05B 1/00

(52) U.S. Cl. 219/679; 219/221

(57) ABSTRACT

The invention relates to a heat-emitting handling device with a heat reservoir which can be heated by microwave radiation and has a heat capacity, the heat reservoir being a molded part of a polymer and/or resin-bonded aqueous raw material with a mass adequate for the heat-storing capacity.

### BACKGROUND OF THE INVENTION

The invention relates to a heat-emitting handling device.

Heat-emitting handling devices of this type are used in many application areas, including hair-cosmetic devices, such as hair curlers for example, and hot-water bottles, seat cushions etc. The known heat-emitting handling devices have for this purpose a heat reservoir, which is generally filled with hot water or can be heated as and when required and repeatedly by microwave radiation. The filling of the heat reservoir with water leads to a distinct increase in the weight of the handling device, making handling more difficult. Moreover, there is the constant risk of undesired water leakage if the handling device is damaged or worm. Therefore, only water-filled hair curlers with relatively small diameters exist.

### BRIEF SUMMARY OF THE INVENTION

The object of the invention is therefore to provide a heat-emitting handling device which is of a simple construction and allows the production of a lighter heat-emitting handling device.

Provided as a result is a heat-emitting handling device which is able to store heat, consists of a material instable form and can be heated up from the outside by microwave radiation. The molding according to the invention has in this case long heat storage, which can be increased or decreased in a simple way by increasing or reducing the mass of the molding. The heating-up by microwave radiation additionally has a sterilizing effect.

The molding can be produced in selectable three-dimensional shapes according to the type of application area. Heat insulation on the surface to protect against burning is preferably provided and may be formed by fiber flocking or an outwardly directed filament fleece.

A preferred application area is that of hair-styling appliances, in particular hair curlers, which are used for permanent or temporary shaping of straight hair. The wide range of different forms of these hair curlers have in common that hair is at least slightly moistened, wound onto them in strands and securely held there for the time of the treatment with the aid of clamps or pins. However, it is not sufficient simply to leave the hair there for a time; the procedure also includes application of heat or the use of chemical agents to preserve the forming of curls once the hair curlers have been removed again. For such application of heat, which is carried out for a time period of 5 to 30 minutes, the curling element of a hair curler may be formed according to the invention by a molding according to the invention. The application of heat then no longer takes place from the outside, as for example in the case of a handheld or salon hair dryer, but from the inside from the hair curler itself. A curling element comprising the molding, which can be heated by microwave radiation, forms a heat source of its own, that is a heated curler. Before the curling of a strand of hair, this heat source can be energized from the outside and then emits heat from the inside to a wound-on strand of hair. The drying time is considerably shortened as a result, since such a curling element can emit the heat just through the wound-on hair, which has the effect that the stored heat is essentially utilized completely, by contrast with drying with a handheld hair dryer, where most of the heat is dissipated unused.

The molding also has the advantage that it retains heat for much longer than water, so that a curling element comprising the molding provides lighter curlers with the same or better drying and forming effect than hair curlers with a water container. The mass of polymer- or natural-resin-bonded raw material used for the curling element determines the heat-storing capacity. Shorter drying times bring advantages not only for the hairdresser and for use at home but are also less stressful for the hair itself. In addition, the energy-saving effect for a hairdressing salon which has high-powered drying appliances running for hours every day is notable. Microwave ovens with a power of 600 to 1000 watts heat up a full set of molding-type curlers in only 30 seconds, which then retain the heat for 5 to 20 minutes.

Because of the low weight of these curling elements, large curler diameters can also be realized, i.e. the heated curlers according to the invention can cover the full range of customary hair curlers.

A curable thermosetting polycondensate which contains a filler of an aqueous raw material is preferably used as the polymer and/or resin molding compound for producing the molded part. Particularly preferred are aminoplastics (UF), melamine-formaldehyde polymers (MF), phenolics (PF), melamine-phenol-formaldehyde polymers (MPF), unsaturated polyester resins (UP) and melamine-polyester molding compounds (MF+UP).

Alternatively usable are thermoplastic granules which comprise approximately 50% wood in the form of chips or sawdust and also maize and natural resin along with added processing aids and, if appropriate, polymers, such as for example polyester, polyamide, polyethylene, polypropylene or phenolic resin or phenolic, and are sold under the trade name Fasal by the company Austel Research & Development GmbH, Tulln, Austria.

Further refinements and advantages of the invention can be taken from the subclaims and the description which follows.

### BRIEF DESCRIPTION OF THE DRAWINGS

The invention is explained in more detail below on the basis of the exemplary embodiments represented in the accompanying figures.

FIG. 1 shows a longitudinal section of a heat-emitting handling device in the form of a hair curler according to a first exemplary embodiment,

FIG. 2 shows a heat-emitting handling device in the form of a hair curler according to a second exemplary embodiment,

FIG. 3 shows a heat-emitting handling device in the form of a hair curler according to a third exemplary embodiment,

FIG. 4 shows a heat-emitting handling device in the form of a hair curler according to a fourth exemplary embodiment,

FIG. 5 shows a heat-emitting handling device in the form of a heated cushion.

### DETAILED DESCRIPTION OF THE INVENTION

The invention relates to a heat-emitting handling device with a heat reservoir which can be heated by microwave radiation and has a heat-storing capacity which is predeterminable. The heat reservoir is in this case a molded part with a heat-storing capacity which can be influenced by the mass of polymer- and/or natural-resin-bonded aqueous raw material. The mass is selectable, the molded part preferably comprising one piece of material, in order to form an element with the most uniform possible material distribution, so that a mass of raw material that is predominantly distributed continuously is achieved. The heating of the molded part then leads to heat storage that is preferably distributed uniformly over the element. As a result, cold regions on the heat-emitting molded part can be avoided. The molded part is a molding produced by thermoforming. The molded part is preferably a molding produced by compression and transfer molding or injection molding, which has preferably also been tempered after its shaping; to increase its heat resistance, for example tempered at temperatures between 100° C. and 135° C. For example, the molded part is injection-molded as a hollow cylinder or as a solid piece.

The molded part is formed from a polymer and/or resin molding compound with an aqueous raw material as filler which is heated under microwave radiation and emits the heat only slowly on account of its good heat-storing capacity

Preferred as the polymer or resin component is a hardened thermoplastic polycondensate. The molded part preferably contains as the polymer or resin component a hardened aminoplastic molding compound of a urea-formaldehyde polymer (UF) or a hardened molding compound of a melamine-formaldehyde polymer (MF) or a hardened phenolic molding compound of a phenol-formaldehyde polymer (PF) or a hardened molding compound of a melamine-phenol-formaldehyde polymer (modified MF or MPF) or a hardened molding compound of an unsaturated polyester resin (UP) or a hardened molding compound of a melamine-polyester molding compound (MF+UP). Bakeklite is cited for example as a trade name for the molding compounds. The polymer or resin component preferably lies below 50%, alternatively preferably at 50 to 60%.

Organic and/or inorganic fillers can be used as the aqueous raw material. Preferred as the inorganic filler is mineral powder or mineral fibers. Preferred as the organic filler is wood in the form of chips and/or sawdust, if appropriate with admixed maize in the form of flour and/or grit, or cellulose. The proportion of aqueous raw material in the molding compound is preferably at least 30 to 40%, particularly preferably at least 50%, in particular 75-85%.

The aforementioned molding compounds are supplied in a powdered, fibrous, chopped-up form or as granules and, apart from the polymer and/or resin component and the filler, they may contain processing additives such as in particular lubricating agents, water, release agents, plasticizers etc.

Alternatively, the polymer or resin component comprises a biodegradable polymer. For example, to produce wood injection-molding granules, the aqueous raw material is natural-resin-bonded. The natural resin imparts the biodegradability, it being possible for processing additives such as natural oils, plasticizers, pigments, release agents etc. to be contained. Granules of this raw material, which can be processed on conventional plastics injection-molding machines, are known from the company AUSTEL Research & Development GmbH under the type designation FASAL F 134. Blends of this raw material with a polymer component of, for example, polyester, polyamide, polypropylene or polyethylene are available under the type designation FASAL F 465.

The molded part is sheathed with a heat insulation in a region which is to be grasped. The heat insulation may be formed as a fiber flocking, which, using an adhesive as a mediator, fixes on the molded part fibers which can be applied in a velvety manner with fiber lengths of 1 to 5 mm. The fiber flocking preferably consists of heat-resistant nylon or polyester. Alternatively or additionally, textile fabrics with an outwardly directed fiber or filament fleece, including Velcro tapes, may be applied to the molded part as heat insulation. Insulating materials of this type have small air-filled voids between the fibers, which allow a user to take hold of the region of the heat-emitting handling element which is to be grasped without inadvertently burning his fingers.

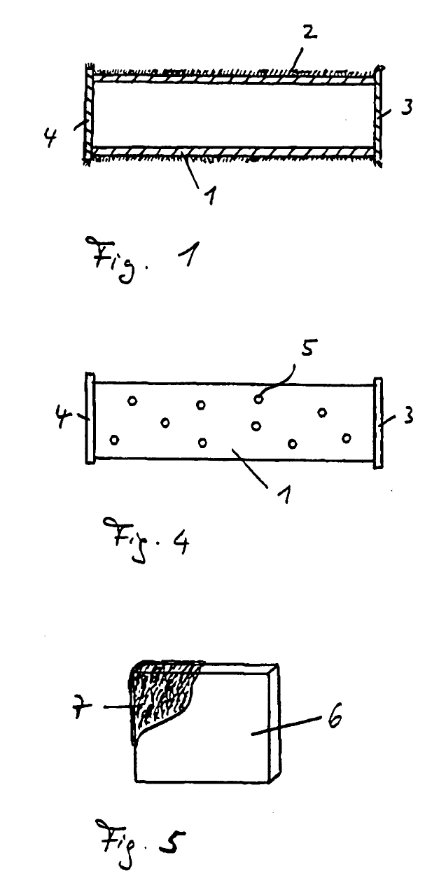

FIG. 1 shows a hair curler according to a first exemplary embodiment, with a curling element which is formed by a molded part 1 of a polymer- and/or resin-bonded aqueous raw material. The molded part 1 is formed as a hollow cylinder, the circumferential surface of which is sheathed by a heat insulation 2. The molded part 1 is closed at the end faces, preferably on one or both sides, by means of sides 3, 4, which preferably also consist of a polymer- and/or resin-bonded aqueous raw material. The sides 3, 4 may be firmly connected to the circumferential surface or formed as a detachable cover. The molded part 1 may have the diameters typical for hair curlers of 10 to 50 mm.

In order that the mass of such a hair curler is adequate for a desired heat-storing capacity, these hair curlers made of a polymer- and/or resin-bonded raw material preferably have a hollow-cylinder wall thickness of 3 to 6 mm.

The heat insulation 2 can likewise be formed as above; flocking with nylon, perlon or cotton fibers is preferred, the lengths of which may lie in the range from 1 to 4 mm and adhere in dense arrangement on the circumferential surface of the molded part 1 with an adhesive as a mediator.

For such a hair curler to be used, it is exposed to microwave radiation for a few seconds, whereby the hair curler is heated preferably to 80° C. to 90° C. Hair to be dried is then wound up onto this heated hair curler.

The heat insulation 2 described above preferably forms at the same time a winding aid.

For fixing the hair curler in the hair, known clamps may be used.

FIG. 2 shows a second exemplary embodiment, which differs from the first exemplary embodiment in that a Velcro tape 8, which represents a winding and fastening aid, is arranged on the heat insulation 2 applied to the outer side on the circumferential surface of the hair curler. The Velcro tape 8 placed around on the circumferential surface of the molded part 1 and over the heat insulation has outwardly directed Velcro tape hooks 9. Furthermore, end face 4 is closed, while the opposite end face is open.

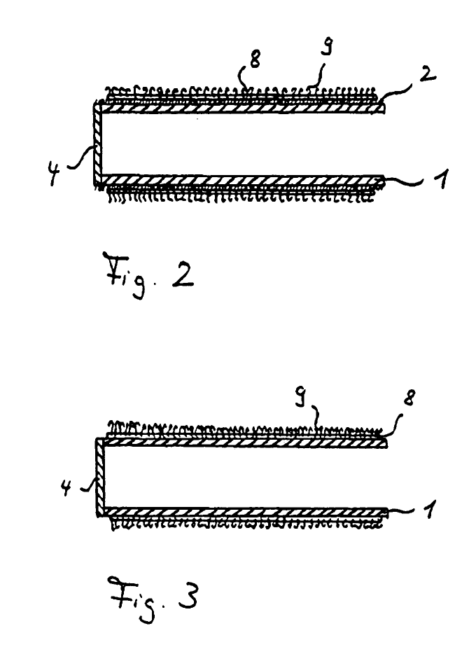

FIG. 3 shows a third exemplary embodiment, which differs from the first exemplary embodiment in that a Velcro tape 8 is arranged directly on the circumferential surface of the molding 1, in other words no fiber flocking is provided since the heat insulation is undertaken by the Velcro tape 8. Furthermore, only one end face 4 is closed, while the opposite end face is open.

FIG. 4 shows a molded part according to a fourth exemplary embodiment, which differs from the first exemplary embodiment in that the hollow cylinder has arranged in a distributed manner in its circumferential surface fine air holes 5, which may be excluded from the heat insulation not represented or else be covered by it, if for example a Velcro tape sheaths the molded part 1. Air circulation from the space inside the molded part 1 can be achieved through the air holes 5. Furthermore, in the case in which the space inside the molded part 1 is filled with a vaporizable or evaporating medium, the release of this medium into the respectively wound-on hair can be brought about while the hair is being heated.

FIG. 5 shows a heat-emitting handling device in the form of a heated cushion. The heated cushion comprises a piece of sheet 6 of a polymer- and/or natural-resin-bonded raw material as described above. Heat insulation 7, which is partly cut away in FIG. 3, preferably surrounds the piece of sheet 6 in the manner of a covering.

According to further exemplary embodiments which are not represented, the molded part may, for example, form a comb, the bristle-carrying element of a brush, the hot region of a hot-water bottle etc.

Although the invention has been described in detail on the basis of illustrations and examples for better understanding, it goes without saying that amendments and modifications that are likewise covered by the invention can be carried out.

What is claims is:

1. A heat-emitting hair curler comprising a heat reservoir capable of being heated by microwave radiation and having a heat capacity, the heat reservoir being a molded part of a polymer- and/or resin-bonded aqueous raw material with a mass adequate for the heat-storing capacity forming the curling element of a hair curler.

2. The hair curler according to claim 1, wherein the aqueous raw material is an organic filler selected from the group consisting of wood, cellulose and maize in the form of chips or flour.

3. The hair curler according to claim 1, wherein the aqueous raw material is an inorganic filler selected from the group consisting of mineral powder and mineral fibers.

4. The hair curler according to claim 1 wherein the polymer or resin component of the molded part is less than 50%.

5. The hair curler according to claim 1, wherein the polymer or resin component of the molded part ranges from 50 to 60%.

6. The hair curler according to claim 1, wherein the molded part contains as the polymer or resin component a hardened thermosetting polycondensate.

7. The hair curler according to claim 1, wherein the molded part contains as the polymer or resin component a hardened aminoplastic molding compound of a urea-formaldehyde polymer (UF).

8. The hair curler according to claim 1, wherein the molded part contains as the polymer or resin component a hardened molding compound of a melamine-formaldehyde polymer (MF).

9. The hair curler according to claim 1, wherein the molded part contains as the polymer or resin component a hardened phenolic molding compound of a phenol-formaldehyde polymer (PF).

10. The hair curler according to claim 1, wherein the molded part contains as the polymer or resin component a hardened molding compound of a melamine-phenol-formaldehyde polymer (modified MF or MPF).

11. The hair curler according to claim 1, wherein the molded part contains as the polymer or resin component a hardened molding compound of an unsaturated polyester resin (UP).

12. The hair curler according to claim 1, wherein the molded part contains as the polymer or resin component a hardened molding compound of a melamine-polyester resin molding compound (MF+UP).

13. The hair curler according to claim 1, wherein the polymer component includes a biodegradable polymer.

14. The hair curler according to claim 1, wherein the molded part is a thermoplastic material of wood.

15. The hair curler according to claim 1, wherein the molded part also comprises polypropylene, polyester, polyamide, polyethylene as the polymer component.

16. The hair curler according to claim 1, wherein the molded part is sheathed with a heat insulation in a region which is to be grasped.

17. The hair curler according to claim 16, wherein the heat insulation is formed as a fiber flocking.

18. The hair curler according to claim 17, wherein the fiber flocking consists of heat-resistant nylon or polyester.

19. The hair curler according to claim 16, wherein the heat insulation is formed by a textile, outwardly directed fiber or filament pile.

20. The hair curler according to claim 1, wherein the curling element has on its circumferential surface an outer fiber flocking, on which a Velcro tape is situated.

21. The hair curler according to claim 1, wherein a Velcro tape is situated on the circumferential surface of the curling element.

22. The hair curler according to claim 1, wherein the curling element is formed as a hollow cylinder.

23. The hair curler according to claim 22, wherein the hollow cylinder is closed at one end face.

24. The hair curler according to claim 22, wherein the hollow cylinder can be filled with a medium vaporizing under the influence of heat, the hollow cylinder being closed at the end faces and having in its circumferential surface provided with air holes to release the vaporizable medium.

25. The hair curler according to claim 22, wherein the hollow cylinder is surrounded on its circumferential surface with an insulating material which has small air-filled voids.

26. The hair curler according to claim 1, wherein the molded part is a molding produced by thermoforming.

27. The hair curler according to claim 1, wherein the molded part is a molding produced by compression and transfer molding or injection molding.

28. The hair curler according to claim 1, wherein the molding has been tempered after its shaping to increase the heat resistance.
